(19) United States
(12) Patent Application Publication
(10) Pub. No.: US 2012/0168397 A1
(43) Pub. Date: Jul. 5, 2012

(54) HOIST APPARATUS AND CONTROL METHOD THEREOF

(75) Inventors: San Lim, Suwon-si (KR); Kwang Kyu Lee, Yongin-si (KR); Kyung Won Moon, Seongnam-si (KR); Kyung Shik Roh, Seongnam-si (KR)

(73) Assignee: SAMSUNG ELECTRONICS CO., LTD., Suwon-si (KR)

(21) Appl. No.: 13/298,812

(22) Filed: Nov. 17, 2011

(30) Foreign Application Priority Data
Jan. 5, 2011 (KR) 10-2011-0000920

(51) Int. Cl. B66C 13/06; B66D 1/24; B66C 17/00; B66D 1/36; B66D 1/48

(52) U.S. Cl. 212/273; 254/334; 254/270

(57) ABSTRACT

A hoist apparatus including a hoist and control method are provided. The hoist includes a cable to which an object is connected, a motor, a drum to wind or unwind the cable in linkage with rotation of the motor, a pulley connected to the drum via the cable to guide the cable to the drum, and an angle detection assembly to detect an angle of the cable between the pulley and the object. A control unit detects whether the object shakes based on the angle of the cable and controls shaking restriction if shaking of the object is detected. User force and angle of the cable are detected and movement of the object is controlled, the object is easily moved by the user, auxiliary force is applied to the object, and vibration of the object is minimized.

### CROSS-REFERENCE TO RELATED APPLICATIONS

This application is related to and claims priority to Korean Patent Application No. 10-2011-0000920, filed on Jan. 5, 2011 in the Korean Intellectual Property Office, the disclosure of which is incorporated herein by reference.

### BACKGROUND

1. Field

The embodiments discussed herein relate to a hoist apparatus and a control method thereof to control transportation of an object.

2. Description of the Related Art

Hoists lift and move an object using, for example, a cable.

Hoists may include a chain hoist which lifts a heavy object using a chain, an air hoist in which a drive device may be rotated by compressed air to wind up a cable on a drum, and an electric hoist which is movably suspended from a rail to raise or lower an object by operating a motor using a lever.

The electric hoist is a windup device including a motor, speed reducer, drum, cable, etc. As the cable is wound on the drum via operation of the motor and speed reducer provided in the electric hoist, an object caught by the cable is raised and then moved. If the object caught by the cable reaches a target location, the cable is unwound from the drum via operation of the motor and speed reducer, allowing the object caught by the cable to be lowered and placed on the target location.

With such a hoist, since a user commands a movement speed and direction of the object by operating a lever or button provided separately from the object, the user cannot simultaneously perform holding and movement of the object, which makes intuitively lifting and moving the object difficult.

To address this problem, instead of controlling the hoist using the lever or button, a force sensor has been attached to a hook of the cable to detect user force in a vertical direction (z-direction) during movement of the object and assists in applying auxiliary force in the detected direction of force.

However, such a method using the force sensor has difficulty detecting force applied in a direction parallel to the ground, i.e., along the X-axis or the Y-axis during movement of the object, thus having difficulty assisting in applying auxiliary force along the X-axis or the Y-axis. In addition, such a method has difficulty restricting vibration generated during movement of the object.

### SUMMARY

It is an aspect of the present invention to provide a hoist apparatus and a control method thereof in which user force and the angle of a cable to which an object is connected are detected to assist user force.

It is an aspect of the present invention to provide a hoist apparatus and a control method thereof in which an object is movable along the X-axis or the Y-axis parallel to the ground in response to a user command.

It is an aspect of the present invention to provide a hoist apparatus and a control method thereof in which shaking of an object is detected based on change in the angle of a cable, thereby enabling restriction of vibration of the object.

Additional aspects of the invention will be set forth in part in the description which follows and, in part, will be obvious from the description, or may be learned by practice of the invention.

In accordance with an aspect of the invention, a hoist apparatus includes a hoist including a cable to which an object is connected, a rotating motor, a drum to wind or unwind the cable in linkage with rotation of the motor, a pulley connected to the drum via the cable to guide the cable to the drum, and an angle detection assembly to detect an angle of the cable located between the pulley and the object, and a control unit to detect, based on the angle of the cable, whether shaking of the object occurs and control restriction of shaking if shaking of the object is detected.

The hoist apparatus may include a first guide rail to guide movement of the object along the X-axis, and a first motor provided at the first guide rail to apply auxiliary force to move the object along the X-axis, and the control unit may detect user force applied to the object based on the angle of the cable, and may control the first motor if user force is detected.

The hoist apparatus may include a second guide rail connected perpendicularly to the first guide rail to guide movement of the object along the Y-axis, a second motor provided at the second guide rail to apply auxiliary force to move the object along the Y-axis, and a force detector to detect force applied to the pulley, the control unit may detect, based on the angle of the cable and the force applied to the pulley, whether user force is applied to the object and if user force is detected, may detect a direction in which the user force is applied, and may control driving of the first motor or the second motor according to the detected direction of force.

The control unit may detect a weight of the object based on a force value from the force detector in a state in which the control unit controls the motor of the hoist to raise the object connected to the cable to a predetermined height, and may control rotational power of the first motor or the second motor based on the weight of the object.

The hoist apparatus may include a second guide rail connected perpendicularly to the first guide rail to guide movement of the object along the Y-axis, a second motor provided at the second guide rail to apply auxiliary force to move the object along the Y-axis, and a torque detector to detect torque of the motor of the hoist, and the control unit may detect force applied to the cable based on the torque, detects, based on the angle of the cable and the force applied to the cable, whether user force is applied to the object, may detect a force in which user force is applied if the user force is detected, and may control driving of the first motor or the second motor according to the detected direction of force.

The control unit may detect a weight of the object based on a torque value from the torque detector in a state in which the control unit controls the motor of the hoist to raise the object connected to the cable to a predetermined height, and may control rotational power of the first motor or the second motor based on the weight of the object.

The motor of the hoist may apply auxiliary force to move the object along the Z-axis.

The motor of the hoist may be a brake motor provided with a brake, and the control unit may control the brake if shaking of the object is not detected.

The angle detection assembly may include a roller installed to hold the cable and adapted to be rotated according to movement of the cable, a plate to which the roller is installed, the plate having an angle corresponding to the angle of the cable, and an angle detector to detect the angle of the plate.

The angle detector may be an encoder or a potentiometer.

The hoist may include a speed reducer to reduce a speed of the motor based on a predetermined reduction gear ratio and transmit the reduced speed to the drum.

In accordance with an aspect of the present invention, a hoist apparatus includes a plurality of guide rails having different axes, a hoist including a cable to which an object is connected, a pulley to guide the cable, a drum connected to the pulley via the cable and adapted to wind or unwind the cable, a motor connected to the drum to apply rotational power to the drum, and an angle detection assembly to detect an angle of the cable, the hoist being mounted to at least one of the plurality of guide rails so as to be moved along a plurality of axes and being moved by user force, a motor provided at each of the plurality of guide rails to supply force to the hoist to move the hoist, a force detector to detect the user force applied to the hoist, and a control unit to determine, based on change in the angle of the cable, whether shaking of the object occurs, control restriction of shaking if shaking of the object is detected, determine a direction of the force if the force is detected, and control driving of the motor provided at the guide rail having an axis corresponding to the determined direction of force.

The control unit may detect a weight of the object based on a torque value from the force detector in a state in which the control unit controls the motor of the hoist to raise the object connected to the cable to a predetermined height, and may control rotational power of the motor provided at the guide rail based on the weight of the object.

The force detector may detect tension of the cable applied to the pulley of the hoist.

The force detector may detect torque of the motor of the hoist and may detect force corresponding to the torque.

In accordance with an aspect of the present invention, a control method of a hoist apparatus including a motor, a drum connected to the motor, a pulley linked to the drum, and a cable wound on the drum and the pulley to transport an object, includes detecting an inclination angle of the cable, determining, based on the angle, whether shaking of the object occurs, controlling restriction of shaking if shaking of the object is detected, determining, based on change in the angle, whether the object is moved, and controlling application of auxiliary force to the object if it is determined that the object is moved.

Determining whether the object is moved may include detecting change in force applied to the cable based on a weight of the object, and determining, based on change in the force, whether the object is moved.

The control method may include raising the object to a predetermined height if the object is connected to the cable, detecting force applied to the cable, and detecting the weight of the object based on the force.

Controlling application of auxiliary force to the object may include detecting a magnitude and direction of force applied to the cable, and applying auxiliary force to the object in the detected direction according to the magnitude and direction of force.

The control method may include raising the object to a predetermined height if the object is connected to the cable, detecting torque of the motor, and detecting the weight of the object based on the torque.

Controlling application of the auxiliary force to the object may include detecting torque of the motor, detecting a magnitude and direction of force based on the torque, and applying auxiliary force to the object in the detected direction according to the magnitude and direction of force.

The control method may include operating a brake of the motor if shaking of the object is not detected and the object is stationary.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates a hoist apparatus according to an exemplary embodiment;

FIGS. 2 and 3 illustrate a hoist provided in a hoist apparatus according to an exemplary embodiment;

FIG. 4 illustrates an angle detection assembly provided in a hoist according to an exemplary embodiment;

FIG. 5 is a control block diagram of the hoist apparatus according to an exemplary embodiment; and

FIG. 6 illustrates a control method of the hoist apparatus according to an embodiment.

### DETAILED DESCRIPTION

Reference will now be made in detail to exemplary embodiments of the present invention, examples of which are illustrated in the accompanying drawings, wherein like reference numerals refer to like elements throughout.

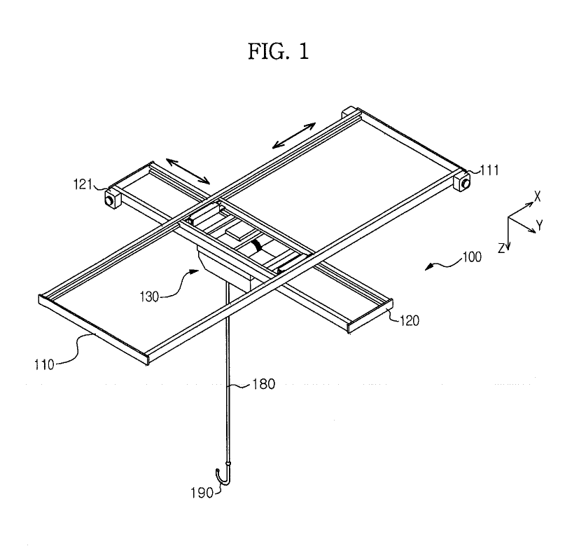

FIG. 1 illustrates a hoist apparatus according to an embodiment.

The hoist apparatus 100 may be selected from among various types including, for example, overhead traveling cranes, wall-mounted cranes, jib cranes, climbing cranes, and tower cranes.

According to an exemplary-embodiment, an overhead traveling crane type hoist apparatus 100 may have three degrees of freedom in X-, Y- and Z-axes.

As illustrated in FIG. 1, the hoist apparatus 100 includes a first guide rail 110, a second guide rail 120, and a hoist 130. The first guide rail 110, second guide rail 120 and hoist 130 of the hoist apparatus 100 may have a stack structure.

The first guide rail 110 guides X-axis movement of an object 200 upon a user applying force to the hoist 130 along the X-axis.

The first guide rail 110 may be secured to the ceiling and the second guide rail 120 may be installed to the bottom of the first guide rail 110. The second guide rail 120 may be movable along the first guide rail 110. Thus, the hoist 130 mounted to the second guide rail 120 is movable along the X-axis.

The first guide rail 110 may be provided with a rack (not shown), and the rack may be engaged with a pinion (not shown) provided at the second guide rail 120.

At least one first motor 111 may be mounted to the first guide rail 110. The first motor 111 applies auxiliary force to the hoist 130 when the user moves the hoist 130 along the X-axis.

The first motor 111 may be connected to the pinion of the second guide rail 120 to provide the pinion of the second guide rail 120 with rotational power.

The first motor 111 may be connected to the pinion of the second guide rail 120 via a gear row (not shown) or a wire (not shown).

If a shaft of the first motor 111 is connected to a shaft of the pinion of the second guide rail 120 via the gear row, as the first motor 111 is driven when the user moves the hoist 130, the gear row and consequently, the pinion of the second guide rail 120 are rotated. As such, the first motor 111 applies auxiliary force to the hoist 130. If the shaft of the first motor 111 is connected to the shaft of the pinion of the second guide rail 120 via the wire, the first motor 111 is driven when the user moves the hoist 130 such that the wire is wound on or unwound from the shaft of the first motor 111, thereby applying auxiliary force to the hoist 130.

The first motor 111 is driven to ensure easy X-axis movement of the hoist 130. The first motor 111 may be rotated in a forward direction if the hoist 130 moves along the X-axis from a reference position in a positive direction (i.e. rightward), and may be rotated in a reverse direction if the hoist 130 moves along the X-axis from the reference position in a negative direction (i.e. leftward).

That is, the first motor 111 provided at the first guide rail 110 is driven to guide X-axis movement of the hoist 130 along the rack.

The second guide rail 120 guides Y-axis movement of the hoist 130 if the user applies force to the hoist 130 along the Y-axis. The second guide rail 120 and the first guide rail 110 may be installed perpendicular to each other.

The second guide rail 120 may be installed at the top thereof to the first guide rail 110 so as to move along the X-axis, and the hoist 130 may be installed to the bottom of the second guide rail 120 so as to move along the Y-axis.

The top of the second guide rail 120 may be provided with the pinion (not shown) engaged with the rack of the first guide rail 110, and the bottom of the second guide rail 120 is provided with a rack (not shown) engaged with a pinion (not shown) of the hoist 130.

At least one second motor 121 may be mounted to the second guide rail 120. The second motor 121 applies auxiliary force to the hoist 130 when the user moves the hoist 130 along the Y-axis.

The second motor 121 may be connected to the pinion of the hoist 130 to provide the pinion of the hoist 130 with rotational power.

The second motor 121 may be connected to the pinion of the hoist 130 via a gear row (not shown) or a wire (not shown).

If a shaft of the second motor 121 is connected to a shaft of the pinion of the hoist 130 via the gear row, as the second motor 121 is driven when the user moves the hoist 130, the gear row and consequently, the pinion of the hoist 130 are rotated. As such, the second motor 121 applies auxiliary force to the hoist 130. A If the shaft of the second motor 121 is connected to the shaft of the pinion of the hoist 130 via the wire, the second motor 121 is driven when the user moves the hoist 130 such that the wire is wound on or unwound from the shaft of the second motor 121, thereby applying auxiliary force to the hoist 130.

The second motor 121 is driven to ensure easy Y-axis movement of the hoist 130. The second motor 121 may be rotated forward if the hoist 130 moves along the Y-axis from a reference position in a positive direction (i.e. forward), and may be rotated in reverse if the hoist 130 moves along the Y-axis from the reference position in a negative direction (i.e. rearward).

That is, the second motor 121 provided at the second guide rail 120 is driven to guide Y-axis movement of the hoist 130 along the rack.

The top of the hoist 130 may be provided with the pinion (not shown) engaged with the rack of the second guide rail 120. Thus, the hoist 130 moves the object 200 along the second guide rail 120 along the Y-axis.

The hoist 130 includes a cable 180 provided with a hook 190 from which the object 200 is suspended. The hoist 130 moves the object along the Z-axis as the user applies force to the cable 180 along the Z-axis.

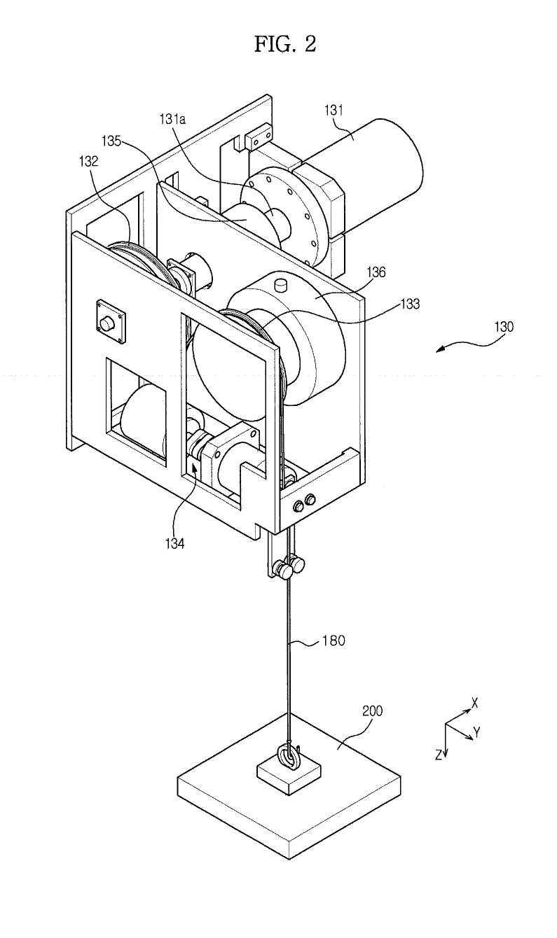

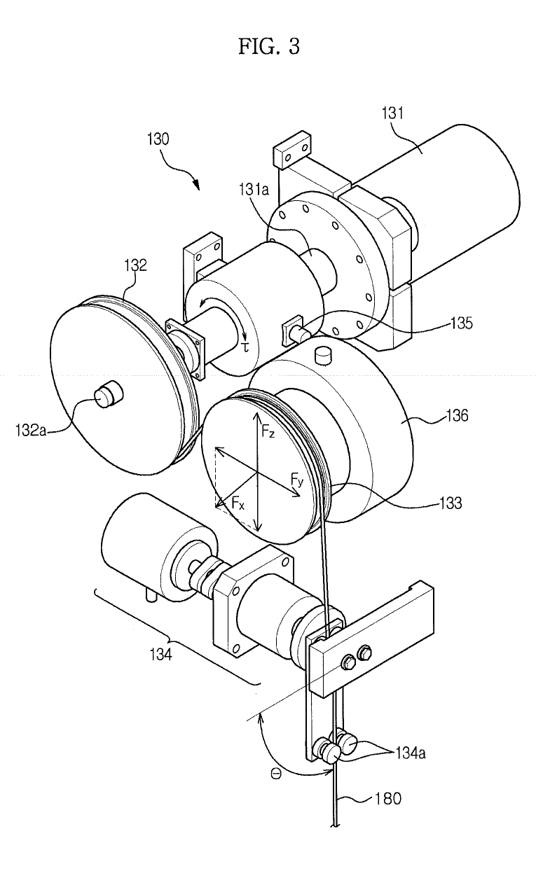

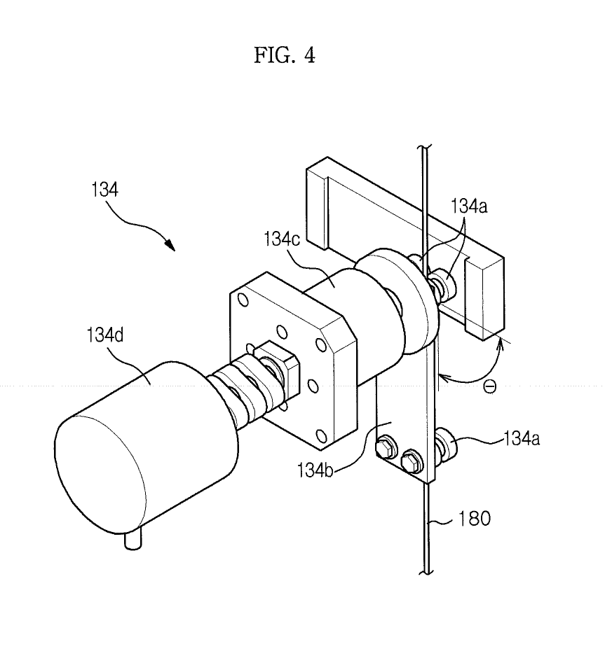

FIGS. 2 and 3 illustrate a hoist provided in an hoist apparatus according to an embodiment, and FIG. 4 illustrates an angle detection assembly provided in a hoist according to an embodiment.

The hoist 130 includes a third motor 131, a drum 132, a pulley 133, an angle detection assembly 134, a torque detector 135, and a force detector 136.

The hoist 130 may include at least one of the torque detector 135 and the force detector 136. According to an exemplary embodiment both the torque detector 135 and the force detector 136 may be included.

The third motor 131 may be rotated forward to wind the cable 180 on the drum 132 and the pulley 133 and may be rotated in reverse to unwind the cable 180 from the drum 132 and the pulley 133. As such, the object 200 is vertically movable along the Z-axis.

The third motor 131 may be rotated forward if the object 200 moves along the Z-axis from a reference position in a positive direction (i.e. upward), and may be rotated in reverse if the object 200 moves along the Z-axis from the reference position in a negative direction (i.e. downward).

The third motor 131 applies auxiliary force to a user force when the user moves the object 200 along the Z-axis.

Thus, the third motor 131 ensures easy Z-axis movement of the hoist 130.

The third motor 131 enables automated vertical movement of the object 200 in response to a command input by the user.

The third motor 131 may be a brake motor provided with a brake, which is operated in a suspension state in which user force is not applied and motion is not detected, thereby reducing energy consumption.

The brake provided at the third motor 131 may be accommodated in a case of the third motor 131 and operated when power is not supplied to the third motor 131 and stops operation when power is supplied to the third motor 131.

The brake may be operated as a brake shoe is compressed against a brake disc using electromagnetic force, or may be an electronic clutch brake.

The hoist apparatus may include a speed reducer (not shown) to regulate the rotational speed of the third motor 131.

The third motor 131 may be rotated at a rated speed and The rotational speed of the third motor 131 is regulated by the speed reducer. Thereby, the rotational speed of the third motor 131 reduced by the speed reducer is transmitted to the drum 132, which enhances operation safety of the third motor 131. The rotational speed of the third motor 131, i.e. revolutions per minute of the third motor 131 is reduced in proportion to a reduction gear ratio of the speed reducer.

A speed reducer may be used so that a small motor may be used since using a large motor requires a wide space, an increased size of peripheral parts required to secure the large motor, thicker wires, and larger associated elements corresponding to the capacity of the motor. The small motor, however, may exhibit excessive heat emission when the speed thereof is reduced and also, may exhibit shortened lifespan and less torque. Thus, the speed reducer may be installed to the third motor having a small capacity.

The third motor 131 has a shaft 131a, and the shaft 131a may be s connected to a shaft 132a of the drum 132. Thereby, the drum 132 may be rotated in linkage with the third motor 131.

Since the third motor 131 may be rotated based on a diameter of the drum 132, a length of the cable 180 wound on the drum 132 and consequently, a height of the cable 180 raised from the ground may be measured. The height of the cable 180 is a height at which the hook 190 is located.

The drum 132 may be rotated based on rotation of the third motor 131, allowing the cable 180 to be wound on or unwound from an outer circumference thereof.

The cable 180 to be wound on the drum 132 is the cable 180 directed from the pulley 133.

If the cable 180 is unwound from the drum 132, the unwound cable 180 is lowered to the ground by way of the pulley 133.

The pulley 133 guides the cable 180 such that the cable 180 is wound on the drum 132 and also, guides the cable 180 unwound from the drum 132 to the ground. That is, the pulley 133 assists in winding the cable 180 on the drum 132 while guiding the cable 180.

If the drum 132 may be rotated as the third motor 131 may be rotated forward, the cable 180 directed from the pulley 133 is wound on the drum 132. As the cable 180 is wound on the drum 132, the cable 180 is raised from the ground, causing the object 200 caught by the cable 180 to be raised.

If the object 200 reaches a target location, the drum 132 may be rotated as the third motor 131 may be rotated in reverse. The cable 180 on the drum 132 is unwound and is directed to the pulley 133, thereby being lowered from the pulley 133 to the ground and causing the object 200 caught by the cable 180 to be lowered.

The object 200 caught by the hook 190 of the cable 180 can be raised or lowered so as to be transported to the target location.

The angle detection assembly 134 detects the angle θ of the cable 180 during raising or lowering of the object 200. More particularly, the angle detection assembly 134 detects the angle of the cable 180 located between the pulley 133 and the object 200.

The angle detection assembly 134, as illustrated in FIG. 4, includes a plurality of rollers 134a, a plate 134b, a rotating member 134c, and an angle detector 134d.

The plurality of rollers 134a may be provided in pairs to hold the cable 180 at opposite sides of the cable 180. In other words, the cable 180 is moved upward or downward between the pair of rollers 134a.

At least two upper and lower pairs of rollers 134a may be provided to hold the cable 180 at opposite sides of upper and lower positions of the cable 180 and especially, the cable 180 located between the pulley 133 and the object 200.

The plurality of rollers 134 is rotatable according to upward or downward movement of the cable 180 to minimize friction with the cable 180 during upward or downward movement of the cable 180.

The plurality of rollers 134a is installed to the plate 134b. If the cable 180 held between the plurality of rollers 134a is moved, the plate 134b is moved in a direction corresponding to a moved direction of the cable 180.

The rotating member 134c is coupled to the plate 134b and may be rotated according to movement of the plate 134b.

The angle detector 134d detects a rotated angle of the rotating member 134c.

The rotated angle of the rotating member 134c is the angle θ of the cable 180 on the basis of the moved direction of the cable 180.

The angle detector 134d may be any one of an incremental encoder, an absolute encoder, a magnetic encoder, and a potentiometer.

The torque detector 135 is provided between the third motor 131 and the drum 132 and detects torque τ of the third motor 131.

The force detector 136 is connected to the pulley 133 and detects tension of the cable 180 applied to the pulley 133.

The force detector 136, as illustrated in FIG. 3, is a multi-axis load cell to detect force along multiple axes. In an exemplary embodiment, the force detector 136 is a dual-axis force detector to detect force along the Z-axis Fz and force along the Y-axis Fy. In this case, force along the X-axis Fx can be detected using the force along the Z-axis Fz and force along the Y-axis Fy.

Alternatively, the force detector 136 may be a single-axis load cell corresponding to each of a plurality of axes.

Alternatively, the torque detector 135 and the force detector 136 may be a multi-axis force and torque sensor to detect components of user force Fx, Fy and Fz along three axes and components of moment applied to the object 200 along three axes.

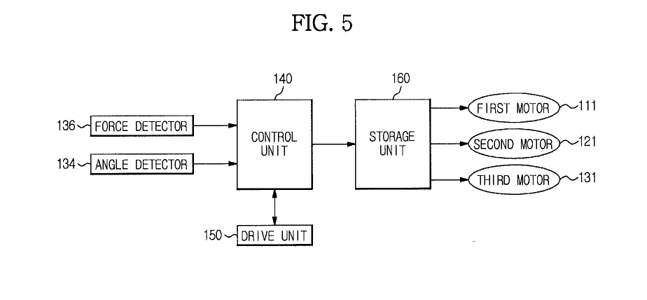

FIG. 5 is a control block diagram of a hoist apparatus according to an exemplary embodiment. The hoist apparatus includes the angle detector 134d, the force detector 135, a control unit 140, a storage unit 150, and a drive unit 160.

The angle detector 134d detects the angle of the cable 180 and sends it to the control unit 140.

The angle of the cable 180 is determined by shaking of the object 200 and user force.

The force detector 136 detects tension of the cable 180 and sends it to the control unit 140.

The tension of the cable 180 is determined by the weight of the object 200 and user force.

The control unit 140 detects, based on change in the angle of the cable 180, whether shaking of the object 200 occurs. If shaking of the object 200 exceeds a reference value, the control unit 140 controls driving of the third motor 131 to restrict shaking.

The control unit 140 may determine that the cable 180 is moved if the angle of the cable 180 is a predetermined angle or more and is not changed for a predetermined time. In other words, the control unit 140 determines that the cable 180 is tilted as the object is moved by user force.

In a state in which the control unit 140 controls the third motor 131 of the hoist 130 to raise the object 200 connected to the cable 180 to a predetermined height, the control unit 140 detects the weight of the object 200 based on a force value from the force detector 136 and then, detects whether user force is applied to the object 200 by comparing force applied to the object 200 at a measuring time with force corresponding to the weight of the object 200 after a predetermined time passes. If user force is detected, the control unit 140 detects a direction in which the user force is applied, and controls driving of the first motor 111 or the second motor 121 provided at the guide rail corresponding to the detected direction of force, thereby adding auxiliary force to the user force that is applied to move the object 200.

The weight of the object may be directly determined using a force detector (not shown) installed to the hook 190.

If shaking of the object 200 and user force are not detected, the control unit 140 controls the brake of the third motor 131 to reduce energy consumption.

The storage unit 150 stores data including a predetermined reduction gear ratio to reduce the rotational speed of the third motor 131, a predetermined raising height of the cable 180 with regard to the weight of the object, a total length of the cable 180, a winding length of the cable 180 based on the rotational speed of the third motor 131 and the diameter of the drum 132, the torque of the third motor 131, and the weight of the object corresponding to force applied to the pulley 133.

The drive unit 160 drives the first motor 111, the second motor 121, and the third motor 131 in response to a command of the control unit 140.

The hoist apparatus may control application of auxiliary force to move the object 200 and restriction of vibration of the object 200 using the torque detector 135.

The torque detector 135 detects torque of the third motor 131 and sends it to the control unit 140. The torque of the third motor 131 is determined by the weight of the object 200 and user force.

In a state in which the control unit 140 controls the third motor 131 of the hoist 130 to raise the object 200 connected to the cable 180 to a predetermined height, the control unit 140 detects the weight of the object 200 based on a torque value from the torque detector 135 and then, detects force applied to the cable 180 based on torque of the third motor 131 at a measuring time and torque corresponding to the weight of the object 200 after a predetermined time passes and also, detects whether user force is applied to the object 200 based on the angle and tension of the cable 180. If user force is detected, the control unit 140 detects a direction in which the user force is applied, and controls driving of the first motor 111 or the second motor 121 provided at the guide rail corresponding to the detected direction of force.

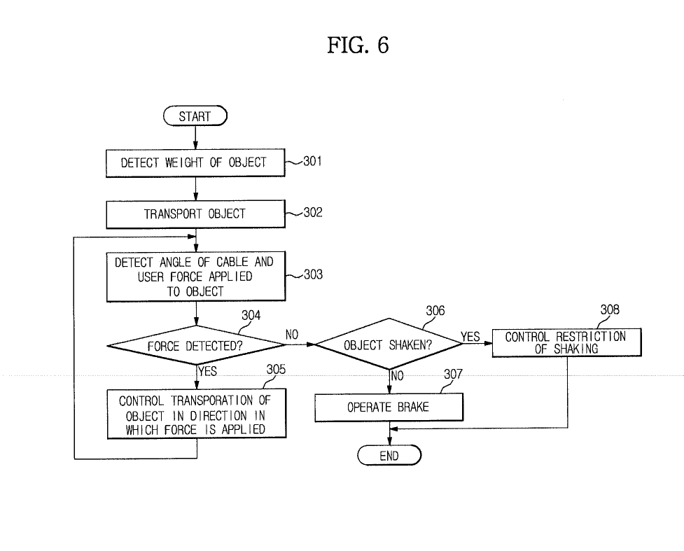

FIG. 6 illustrates a control method of the hoist apparatus according to an exemplary embodiment.

Upon a transportation signal of the object 200 being input to the hoist apparatus, the third motor 131 may be rotated forward.

If the drum 132 is rotated as the third motor 131 is rotated forward, the cable 180 directed from the pulley 133 is wound on the drum 132. In a state in which the object 200 connected to the cable 180 is raised to a predetermined height from the ground as the cable 180 is wound on the drum 132, the hoist apparatus detects the weight of the object 200 based on torque detected by the torque detector 135 or force detected by the force detector 136 (operation 301).

An algorithm to presume the weight of the object and a weight compensation algorithm to offset the weight may be added.

The hoist apparatus raises the object 200 to a height suitable for transportation of the object 200 (operation 302).

The angle of the cable 180 is detected using the angle detector 134d, and user force applied to the object 200 is detected using at least one of the torque detector 135 and the force detector 136 (operation 303). The force detector 136 detects tension of the cable 180 and the torque detector 135 detects torque of the third motor 131.

The hoist apparatus performs dynamic calculation of a current state using detected data, and determines, based on the calculated result, whether the object 200 is stationary or moving and/or whether user force is applied.

Force applied to the cable 180 is detected by comparing force corresponding to the weight of the object 200 with force applied to the object 200 at a measuring time. In this case, if user force is detected (304), the direction in which the user force is applied and the magnitude of the user force are detected, and the first motor 111 or the second motor 121 provided at the guide rail corresponding to the detected direction of force is controlled (305). The rotational speed of the first motor 111 or the second motor 121 may be controlled according to the magnitude of the force.

Thereby, as auxiliary force is added to the user force applied to move the object 200, the object 200 is easily transported in a direction desired by the user. Impedance control may be performed to provide tactile feedback to the user moving a heavy object with low force.

A determination is made as to whether shaking of the object 200 occurs in a state in which force applied to the object 200 is not detected (operation 306).

If the angle θ of the cable 180 is about zero degrees, determine it is determined that the object 200 is stationary, and the brake of the third motor 131 is operated to reduce energy consumption (operation 307).

On the other hand, if the cable 180 shows change in inclination angle, it is determined that shaking of the object 200 occurs. In this case, driving of the third motor 131 is controlled to restrict shaking of the object (operation 308).

Force applied to the cable 180 may detected by comparing torque corresponding to the weight of the object 200 with torque of the third motor 131 at a measuring time. If user force is detected, a direction in which the force is applied is detected and driving of the first motor 111 or the second motor 121 provided at the guide rail corresponding to the detected direction of force is controlled.

Thereafter, if the object 200 is positioned at a target location, the third motor 131 may be rotated in reverse and thus, the drum 132 may be rotated.

The cable 180 is unwound from the drum 132 and is directed to the pulley 133, thereby being lowered from the pulley 133 to the ground and consequently, allowing the object 200 caught by the cable 180 to be lowered.

The object 200 caught by the hook 190 of the cable 180 can be raised or lowered so as to be transported to the target location.

An exemplary embodiment includes a hoist apparatus in which user force applied to an object and the angle of a cable connected to the object are detected and movement of the object is controlled based on the detected force and angle, which ensures that a user may easily move the object in a desired direction, that auxiliary force may be added to assist in moving the object, and that vibration of the object may be minimized when the object stops movement. Advantageous results include in intuitive and convenient movement as well as safe movement of the object.

In addition, a brake may be operated when the object stops movement, which reduces energy consumption.

Although an exemplary embodiment of the present invention has been disclosed and described, it would be appreciated by those skilled in the art that changes may be made in these embodiments without departing from the principles and spirit of the invention, the scope of which is defined in the claims and their equivalents.

What is claimed is:

1. A hoist apparatus comprising:
a hoist including a cable to which an object is connected, a rotating motor, a drum to wind or unwind the cable in linkage with rotation of the motor, a pulley connected to the drum via the cable to guide the cable to the drum, and an angle detection assembly to detect an angle of the cable located between the pulley and the object; and
a control unit to detect, based on the angle of the cable, whether shaking of the object occurs and control restriction of shaking if shaking of the object is detected.

2. The hoist apparatus according to claim 1, comprising:
a first guide rail to guide movement of the object along the X-axis; and
a first motor provided at the first guide rail to apply auxiliary force to move the object along the X-axis,
wherein the control unit detects user force applied to the object based on the angle of the cable, and controls the first motor if user force is detected.

3. The hoist apparatus according to claim 2, comprising:
a second guide rail connected perpendicularly to the first guide rail to guide movement of the object along the Y-axis;
a second motor provided at the second guide rail to apply auxiliary force to move the object along the Y-axis; and
a force detector to detect force applied to the pulley,
wherein the control unit detects, based on the angle of the cable and the force applied to the pulley, whether user force is applied to the object and if user force is detected, detects a direction in which the user force is applied, and controls driving of the first motor or the second motor according to the detected direction of force.

4. The hoist apparatus according to claim 3, wherein the control unit detects a weight of the object based on a force value from the force detector in a state in which the control unit controls the motor of the hoist to raise the object connected to the cable to a predetermined height, and controls rotational power of the first motor or the second motor based on the weight of the object.

5. The hoist apparatus according to claim 2, comprising:
a second guide rail connected perpendicularly to the first guide rail to guide movement of the object along the Y-axis;
a second motor provided at the second guide rail to apply auxiliary force to move the object along the Y-axis; and
a torque detector to detect torque of the motor of the hoist,
wherein the control unit detects force applied to the cable based on the torque, detects, based on the angle of the cable and the force applied to the cable, whether user force is applied to the object, detects a force in which user force is applied if the user force is detected, and controls driving of the first motor or the second motor according to the detected direction of force.

6. The hoist apparatus according to claim 5, wherein the control unit detects a weight of the object based on a torque value from the torque detector in a state in which the control unit controls the motor of the hoist to raise the object connected to the cable to a predetermined height, and controls rotational power of the first motor or the second motor based on the weight of the object.

7. The hoist apparatus according to claim 1, wherein the motor of the hoist applies auxiliary force to move the object along the Z-axis.

8. The hoist apparatus according to claim 1, wherein the motor of the hoist is a brake motor provided with a brake, and
wherein the control unit controls the brake if shaking of the object is not detected.

9. The hoist apparatus according to claim 1, wherein the angle detection assembly includes:
a roller installed to hold the cable and adapted to be rotated according to movement of the cable;
a plate to which the roller is installed, the plate having an angle corresponding to the angle of the cable; and
an angle detector to detect the angle of the plate.

10. The hoist apparatus according to claim 9, wherein the angle detector is any one of an encoder or a potentiometer.

11. The hoist apparatus according to claim 1, wherein the hoist includes a speed reducer to reduce a speed of the motor based on a predetermined reduction gear ratio and transmit the reduced speed to the drum.

12. A hoist apparatus comprising:
a plurality of guide rails having different axes;
a hoist including a cable to which an object is connected, a pulley to guide the cable, a drum connected to the pulley via the cable and adapted to wind or unwind the cable, a motor connected to the drum to apply rotational power to the drum, and an angle detection assembly to detect an angle of the cable, the hoist being mounted to at least one of the plurality of guide rails so as to be moved along a plurality of axes and being moved by user force;
a motor provided at each of the plurality of guide rails to supply force to the hoist to move the hoist;
a force detector to detect the user force applied to the hoist; and
a control unit to determine, based on change in the angle of the cable, whether shaking of the object occurs, control restriction of shaking if shaking of the object is detected, determine a direction of the force if the force is detected, and control driving of the motor provided at the guide rail having an axis corresponding to the determined direction of force.

13. The hoist apparatus according to claim 12, wherein the control unit detects a weight of the object based on a torque value from the force detector in a state in which the control unit controls the motor of the hoist to raise the object connected to the cable to a predetermined height, and controls rotational power of the motor provided at the guide rail based on the weight of the object.

14. The hoist apparatus according to claim 12, wherein the force detector detects tension of the cable applied to the pulley of the hoist.

15. The hoist apparatus according to claim 12, wherein the force detector detects torque of the motor of the hoist and detects force corresponding to the torque.

16. A control method of a hoist apparatus including a motor, a drum connected to the motor, a pulley linked to the drum, and a cable wound on the drum and the pulley to transport an object, comprising:
detecting an inclination angle of the cable;
determining, based on the angle, whether shaking of the object occurs;
controlling restriction of shaking if shaking of the object is detected;
determining, based on change in the angle, whether the object is moved; and
controlling application of auxiliary force to the object if it is determined that the object is moved.

17. The control method according to claim 16, wherein determining whether the object is moved includes:
detecting change in force applied to the cable based on a weight of the object; and
determining, based on change in the force, whether the object is moved.

18. The control method according to claim 17, comprising:
raising the object to a predetermined height if the object is connected to the cable;
detecting force applied to the cable; and
detecting the weight of the object based on the force.

19. The control method according to claim 17, wherein controlling application of auxiliary force to the object includes:
detecting a magnitude and direction of force applied to the cable; and
applying auxiliary force to the object in the detected direction according to the magnitude and direction of force.

20. The control method according to claim 17, comprising:
raising the object to a predetermined height if the object is connected to the cable;
detecting torque of the motor; and
detecting the weight of the object based on the torque.

21. The control method according to claim 17, wherein controlling application of the auxiliary force to the object includes:
detecting torque of the motor;
detecting a magnitude and direction of force based on the torque; and
applying auxiliary force to the object in the detected direction according to the magnitude and direction of force.

22. The control method according to claim 16, comprising operating a brake of the motor if shaking of the object is not detected and the object is stationary.

23. A controller for a hoist apparatus, the controller comprising:
a detector to detect, based on an angle of a cable to which an object is connected, whether shaking of the object occurs; and
a restrictor to restrict shaking upon shaking of the object being detected.
